(19) United States
(12) Patent Application Publication
(10) Pub. No.: US 2005/0234963 A1
(43) Pub. Date: Oct. 20, 2005

(54) Method and system for transactional log processing

(75) Inventors: Christopher Louis Capps, Garner, NC (US); Sean Dunne, Blackrock (IE); William J. Noonan, Cary, NC (US); Filip Jay Yeskel, Raleigh, NC (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 10/827,020

(22) Filed: Apr. 19, 2004

(51) Int. Cl. G06F 17/30

(52) U.S. Cl. 707/102

(57) ABSTRACT

In a network comprising a first node where raw business data is collected, and a second node connected to the first node, a method for converting the raw business data to transformed data, comprises steps or acts of monitoring the availability of raw business data at the first node and based on either relevant first node or second node conditions the raw business data is transformed to transformed data at respectively the first or second nodes.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of information technology, and more particularly relates to the field of processing information to be transferred throughout a network.

### BACKGROUND OF THE INVENTION

Automated processing of business transactional data is now widely done. However, different aspects of a business process are commonly handled by different application programs provided by different software suppliers. Communication among the different application programs can be difficult because these applications frequently have different data formats and the business process itself may require handling of the data by different nodes in a network that each require different data formats. One example of this phenomenon is found in the processing of a transaction-related (business) data by retail stores and their interprise processing operations that provide data processing services for a plurality of related retail stores. The data record of transactions that occur in a retail store (known as the Transaction Log or TLOG) is the primary information source for retailers regarding their store operations. The TLog typically contains a complete record of everything that happened at the Point of Sale (POS) terminal. It lists, among many other things, what was sold, at what price, by whom, to whom, and with what promotions and similar information. Unsurprisingly, this data, when consolidated for all the stores in the enterprise, is very important to conducting the retailer's business. Consolidated TLOG data provides, for example, the metrics for determining when and what to reorder from suppliers.

The problem is how to optimally transfer and process the multiple forms of TLOG data between stores and centralized enterprise systems. The problem arises because data transformation is not free; the cycles must be spent somewhere. Where is the best place to process the data? The answer can change based on at least four factors: application data format requirements in a given store, application data format requirements at the enterprise, surplus processing power available in a given store, and surplus processing power available at the enterprise. It is not unusual for a large retail enterprise to have thousands of stores. The application configuration in each store may be different and will typically change as old store applications are phased out and new ones are brought online. The surplus, processing power in a given store (e.g., on that store's POS controller) that could be applied to transforming TLOG data will typically change based on POS load which is typically based on both time of day and time of year.

All known existing solutions to this problem are static. In other words, the system designers attempt to find the best configuration for the widest range of possible factors and then use this same data transfer/processing configuration at all times. As opposed to such static solutions, there is a need for an adaptive mechanism which allows the TLOG data transfer/processing configuration to be dynamically optimized for the situation at hand. Another example is the case where stores which require TLOG data in simple XML (extensible markup language) form for in-store applications. Such stores would likely transform the data from binary to simple XML (for use by the in-store applications) and then also transmit the latter format to the enterprise for any subsequent processing required by the enterprise applications.

Raw TLOG data (as it is collected in the store) is typically encoded in a tightly packed binary format. This is an efficient format for interchange with the store's POS terminals, for local (in-store) storage, and for transmission to the enterprise. Efficiency of storage and transmission was a paramount concern in the days of expensive storage and very limited bandwidth. The advent of inexpensive and abundant storage and bandwidth has resolved this concern and business priorities are now shifting towards ease of data integration and use. XML is the preferred data format for this set of business priorities. Thus, with the emergence of XML as the standard format for data interchange, and especially the emergence of a retail industry standard dialect of XML for TLOG data, called IXRetail POSlog, there are now three useful formats for the same TLOG data: binary (raw); simple XML; and IXRetail POSlog XML. Each format is optimized for certain uses and certain applications.

Transferring this data from stores, where it is collected, to the enterprise, where it is consolidated and processed, is typically done today in one of two ways. Data transfer is either via a batch file, typically during the night, or via queue based messaging (e.g., MQ Series) “trickled” during normal store hours. In either case, the transferred TLOG data is almost always still in its original binary format and thus further transformation may be required. Therefore, there is a need for a method for processing TLOGs that dynamically and efficiently utilizes network resources.

### SUMMARY OF THE INVENTION

Briefly, according to an embodiment of the invention, in a network comprising a first node where raw business data is collected, and a second node connected to the first node, a method for converting the raw business data to transformed data, comprises steps or acts of monitoring the availability of raw business data at the first node and determining whether to transform the raw business data to transformed data based on relevant second node conditions. Based on either relevant first node or second node conditions the raw business data is transformed to transformed data at respectively the first or second nodes.

In one embodiment the method is performed by a programmable information processing system running program instructions comprised by a machine-readable medium. In other embodiments the invention may be performed by a specialized application-specific integrated circuit (ASIC).

### BRIEF DESCRIPTION OF THE DRAWINGS

FIG. 1 is a flowchart of a method according to the invention.

FIG. 2 is a high level block diagram showing an information processing system according to the invention.

FIG. 3 shows a data network using an embodiment of the invention.

### DETAILED DESCRIPTION

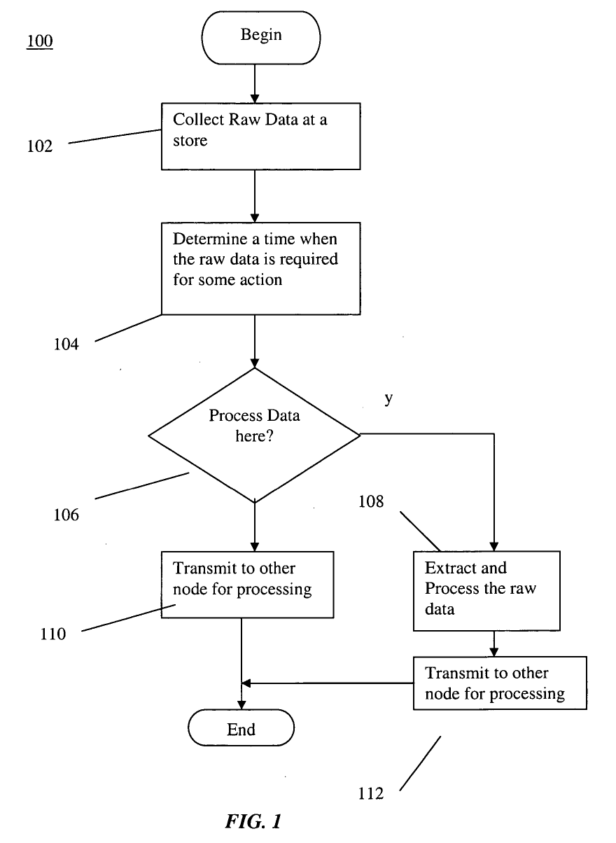

Referring to FIG. 1, there is shown a flow chart illustrating a TLOG processing method 100 according to an embodiment of the invention. One aspect of the invention provides a self-identifying mechanism for packaging business data such as TLOG data that indicates the format of the data contained in the package. Thus in step 102, raw TLOG data is collected at a store (a node) that comprises a processing engine and is connected to a network such as a wide area network. This data is in any format suitable for use within the store environment (e.g., a tightly-packet proprietary format). In step 104 the processing engine determines a period of time when the raw data is to be processed for conversion to transformed data. This period of time may be an interval selected by the programmer or the time at which a certain amount of data is accumulated (e.g., a buffer is filled). In step 106, a determination is made as to whether to process the raw data in the store processor (POS controller) or else to send the raw data to a second site such as the enterprise node for processing. This decision is made based on certain local processing conditions that include the local processing bandwidth and the local as opposed to centralized need for the data. Local processing conditions can also include the processing bandwidth throughout the network. This decision can be made at any node in the network having the required processing power. In one embodiment the store node is autonomous and makes its own decision on what information to process and what information to send out for processing. In another embodiment the enterprise node makes decisions on where processing is to take place based on information provided by nodes such as retail sales nodes. In yet other embodiments, other nodes in the network can make the decisions on where to process data. The conditions include the need for the transformed data in the store node and a low demand for processing (i.e., processing power availability) in the store node during the period of time. If either of these conditions exists the decision is made in step 108 to convert the raw data to transformed data locally (i.e., at the store node). If on the other hand, the processing needs are high (e.g., peak sales hours) in step 110 the decision is made to send the data to a second node, such as the enterprise node, for conversion to transformed data or other processing. The enterprise node, unlike the store node, comprises data on all other store nodes (if any). At least some processing, including entry into an enterprise database, should be done at the enterprise node. Therefore, eventually the data must be sent there. Decision 106 thus concerns whether the processing that can be done at the store node (parsing and some data format conversion) is to be done locally. The transformed data comprises a transformed data format such as XML (extensible markup language) or an industry standard dialect such as IXRetail or POSLog.

There are three major components of processing that must be done with the raw data: (1) parsing; (2) data format transformation; and (3) database storage. The parsing process extracts data portions form each field in the raw data. The transformation transforms the raw data into one of several business-to-business industry standard formats such as XML. The database storage comprises the entry of the data into an enterprise database where data from all other stores is stored. In the preferred embodiment, the data is eventually converted to IXRetail POSLog.

The method can be implemented as a programmable information processing system executing program instructions that perform the above-discussed process or as an application-specific integrated circuit “hardwired” to perform the process.

Another aspect of the invention provides an unpacking mechanism that reads the self-identifying information and routes the data in a way that corresponds to the amount of processing already done and that remains to be done. Thus, for example, stores which, at the moment, have available processing power to transform the TLOG data (either to simple XML or to POSLog XML) may do so on store engines and transfer the data in this form. Stores which, at the moment, do not will transfer the data in binary form and any necessary transformation will be done at the enterprise.

The method 100 can be performed at any suitable node in the network comprising the node (the first node) where raw business data is collected and wherein information relating to transactions conducted at the node is stored and a second node connected to the first node.

In another embodiment, a method for transforming raw data to transformed data comprises the following acts, performed at either the first or second node. In this embodiment, as in the previous embodiment, the first node is preferably a store and the second is an enterprise node. We first determine whether there is a need for the transformed data in the first node. This is usually the case when there is some data processing required to be done at the store (e.g., for inventory control). Next, we determine whether there are sufficient processing resources in the first node to accomplish the transformation in the desired time. The we make the following determinations: (1) whether there are sufficient processing resources in the second node to accomplish the transformation in the desired time; (2) the relative costs of transforming in the first node a opposed to the second node; (3) the network bandwidth implications of transforming in the first node vs. transforming in the second node. Based on these determinations we then determine whether to convert the data in the first node or to cause the data to be sent to the second node for conversion.

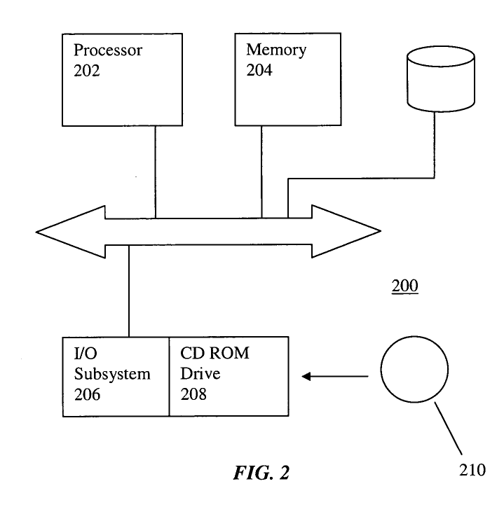

Referring to FIG. 2, there is shown a block diagram of an information handling system 200 according to an embodiment of the invention. The system 200 comprises a processor 202, a memory 204, and an input/output (I/O) subsystem 206.

The memory 204 represents either a random-access memory or mass storage. It can be volatile or non-volatile. The system 200 can also comprise a magnetic media mass storage device such as a hard disk drive.

The I/O subsystem 206 may comprise various end user interfaces such as a display, a keyboards and a mouse (not shown). The I/O subsystem 206 may further comprise a connection to a network such as a local-area network (LAN) or side-area network (WAN) such as the Internet and a CD ROM drive 208.

According to an embodiment of the invention, a computer readable medium, such as a CD ROM 210 can include program instructions for operating the programmable computer 200 according to the invention. What has been shown and discussed is a highly-simplified depiction of a programmable computer apparatus. Those skilled in the art will appreciate that other low-level components and connections are required in any practical application of a computer apparatus.

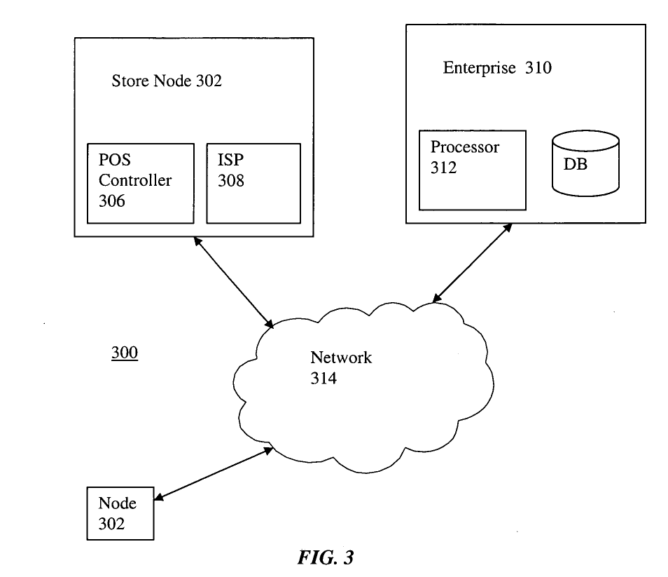

Referring to FIG. 3, there is shown a data network 300 that comprises an enterprise node 302 connected to a plurality of store nodes 304. A typical store node 304 includes a POS controller 306 that processes sales-related data at a POS terminal. The store node also comprises an in-store processor (ISP) 308 that is used for all other computing needs of the store (e.g., employment related data). The enterprise node 310 typically comprises a computer or processor 312 with substantial computing power and a database (DB) for storing sales related data from all of the stores controlled by the enterprise.

The store (POS) node controller 306 collects data on the sale transactions conducted at the store. This includes descriptions of the items or services sold, prices, customer information and other related data. The decision whether to process locally the sales related data or to send it to the enterprise node 310, or another remote node, is made at the store node in a manner such as that discussed above with respect to FIG. 1.

Therefore, while there has been described what is presently considered to be the preferred embodiment, it will understood by those skilled in the art that other modifications can be made within the spirit of the invention.

1. In a network comprising a first node where raw business data is collected, wherein the first node comprises information relating to transactions conducted at the node, and a second node connected to the first node, a method for converting the raw business data to transformed data, the method comprising:
determining a period of time when the raw business data is to be processed for conversion to transformed data;
determining whether to transform the raw data into transformed data in the first node based on relevant local processing conditions, wherein the local processing conditions comprise one of a need for the transformed data in the first node and a availability of processing resources for processing in the first node during the period of time;
converting the raw data to transformed data in the first node if any of the local processing conditions is satisfied; and
sending the raw business data to a second node for conversion to transformed data if none of the local processing conditions is satisfied.

2. The method of claim 1, wherein the period of time is predetermined interval.

3. The method of claim 1, wherein the period of time is based on an amount of the raw data.

4. The method of claim 1 wherein the transformed data comprises a transformed format.

5. The method of claim 4 wherein the transformed data format is XML.

6. The method of claim 4 wherein the transformed data format is IXRetail.

7. The method of claim 4 wherein the transformed data format comprises POSLog data.

8. The method of claim 1 wherein the raw data comprises sales-related data.

9. The method of claim 1 wherein the method further comprises transforming the raw data into the transformed data format at the first node if either of the conditions is met.

10. The method of claim 1, wherein the processing comprises parsing the raw data to extract data from each of a plurality of fields.

11. The method of claim 1, wherein sending the data to a second node for conversion to transformed data, if none of the optimal conditions are satisfied, further comprises converting the raw data to a transformed data format and entering the transformed data into a database.

12. The method of claim 1 wherein determining whether to process the raw business data is done at the first node.

13. The method of claim 1 wherein determining whether to process the raw business data is done at the second node.

14. The method of claim 1 wherein collecting raw business data at a first node comprises collecting raw business data at a store node.

15. The method of claim 1 wherein sending the raw business data to a second node for conversion to transformed data comprises sending the raw business data to an enterprise node for processing.

16. The method of claim 1 wherein the raw business data comprises TLog data and determining whether to process the raw data in the first node is done at the frequency of TLog transfers to the second node.

17. The method of claim 1 wherein local processing conditions include the available processing bandwidth of the network for transmitting the data to the second node.

18. An information processing system comprising:
a processor for collecting raw transactional data;
a memory for storing the raw transactional data; and
a communication subsystem for transmitting the raw data to a second node;
wherein the controller comprises logic for determining a period of time when the raw data is to be processed for conversion to transformed data, and for determining whether to process the raw data in the first node based on local processing conditions, wherein the local processing conditions comprise one of a need for the transformed data in the first node and a demand for processing in the first node during the period of time.

19. The information processing system of claim 18 wherein the logic comprises program code instructions for execution by the processor.

20. The information processing system of claim 18 wherein the logic comprises an application-specific integrated circuit.

21. The information processing system of claim 18 wherein the processor comprises a point of sale controller and the second node is an enterprise node that comprises information.

22. A computer readable medium comprising program instructions for:
collecting raw data at a first node in a network, wherein the first node comprises information relating to transactions conducted at the node;
determining a period of time when the raw data is to be processed for conversion to transformed data;
determining whether to process the raw data in the first node based on local processing conditions, wherein the local processing conditions comprise one of a need for the transformed data in the first node and a demand for processing in the first node during the period of time;
converting the raw data to transformed data in the first node if either of the conditions is met; and
sending the data to a second node for conversion to transformed data if none of the optimal conditions are satisfied.

23. In a network comprising a first node where raw business data is collected, wherein the first node comprises information relating to transactions conducted at the node, and a second node connected to the first node, a method for converting the raw business data to transformed data, the method comprising:
monitoring the availability of raw business data at the first node;
determining whether to transform the raw business data to transformed data based on relevant second node conditions; and
transforming the raw business data to transformed data at the second node when any of the relevant second node conditions is satisfied.

24. The method of claim 23 wherein the relevant second node conditions comprise any of availability of processing resources to process the raw business data at the second node and the relative cost of processing the raw business data at the second as opposed to the first node.

25. The method of claim 23 wherein the determining element comprises considering relevant first node conditions and wherein relevant first node conditions comprise the need for the transformed data at the first node and the availability of processing resources to process the raw business data at the first node.

26. The method of claim 23 wherein the determining element comprises considering relevant network conditions and wherein relevant network conditions comprise the availability of bandwidth to transport the raw business data from the first node to the second node.

27. The method of claim 23 wherein the first node comprises a retail sales operation and the second node comprises an enterprise node coupled to the first node by a network.

28. The method of claim 25 wherein the transforming element comprises transforming the raw business data to transformed data at the first node when any of the relevant first node conditions is satisfied.
